(19) United States
(12) Patent Application Publication
(10) Pub. No.: US 2018/0308383 A1
(43) Pub. Date: Oct. 25, 2018

(54) DEVICE AND METHOD FOR MEASURING IMPLICIT ATTITUDES

(71) Applicant: MILLISECOND SOFTWARE LLC, Seattle, WA (US)

(72) Inventor: Sean Draine, Seattle, WA (US)

(21) Appl. No.: 15/492,477

(22) Filed: Apr. 20, 2017

(51) Int. Cl. G09B 19/00

(52) U.S. Cl. CPC G09B 19/00

(57) ABSTRACT

A first target category and a second target category are rendered to a display. Reaction times of a user are measured between when pairings are rendered to the display and when a user selects the correct target category that items of the pairings are linked to. Each of the pairings includes a member and an item that is linked to the first or second target category. An attitude value toward the first and second target categories is generated based at least in part on the reaction times that are measured.

### TECHNICAL FIELD

This disclosure relates generally to the field of automated association testing which may be used for psychological testing.

### BACKGROUND INFORMATION

Basic and applied research in the social sciences often entails measuring people's attitudes towards certain subjects or concepts. The standard method for measuring attitudes is to simply administer a survey to a group of people that asks them to self-report their attitudes. However, when attitudes involving socially sensitive topics such as race, gender, politics, and/or suicidality are surveyed, self-report measures may become less accurate as the people being surveyed attempt to answer the survey questions according to socially acceptable norms or according to what they believe the expectation of the surveyor is. For example, due to the social stigma around suicide, people may be reluctant to self-identify as struggling with low self-esteem or suicidal thoughts even when they are in fact prone to suicidal thoughts. Thus a simple survey that asks people to self-report their suicidality may be ineffective. A second problem with self-report measures is that people may have subtle attitudes or biases they are not fully aware of, and thus cannot report. For example, many people believe that they are not gender biased and are able to answer surveys in a way that confirms this belief. However, these same people may exhibit observably gender biased behavior in other contexts, whether they know it or not.

Today more than ever, corporations, police departments, municipalities, and academia are interested in employee, clients, and student attitudes toward issues such as race, sexuality, age, and gender. Of course, psychologists also benefit from understanding their patient's attitudes about themselves and others to better provide care for the patients. In the late 1990s, Professor Dr. Anthony Greenwald of the University of Washington and others developed an Implicit Association Test (IAT) to test a subject's attitude toward certain topics or concepts. However, critiques of the IAT have made it desirable to improve the testing of implicit attitudes and researchers have worked to improve upon Dr. Greenwald's initial IAT. Therefore, devices and techniques to accurately and efficiently measure attitudes in general, and especially attitudes or biases toward socially sensitive topics, is desirable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a device for measuring reaction times to generate implicit attitude values, in accordance with an embodiment of the disclosure.

FIG. 2 illustrates an example device including a reaction time engine for measuring reaction times to generate implicit attitude values, in accordance with an embodiment of the disclosure.

FIG. 3 illustrates an example data set that may be utilized to generate implicit attitude values, in accordance with an embodiment of the disclosure.

FIG. 4 illustrates a flowchart showing one example process of generating implicit attitude values by measuring reaction times, in accordance with an embodiment of the disclosure.

FIG. 5 illustrates example reaction time measurement blocks that include pairing to be presented to the user for categorization and reaction time measurement, in accordance with an embodiment of the disclosure.

FIG. 6 illustrates a flowchart showing one example process of generating implicit attitude values by measuring a plurality of reaction times, in accordance with an embodiment of the disclosure.

FIG. 7 illustrates an example mobile device having software buttons for facilitating measuring reaction times, in accordance with an embodiment of the disclosure.

FIG. 8 illustrates a device for measuring reaction times to generate conventional attitude values.

### DETAILED DESCRIPTION

Embodiments of a device and method for measuring attitudes are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In this disclosure, example devices and processes generate implicit attitude values by measuring how quickly users can correctly select a target category that an item of the target category belongs to. The reaction time of the user may be measured by the difference in time of presenting the item to a display and the user correctly selecting a user input (e.g. keyboard key or touchscreen zone) that corresponds with the target category. The user may be presented with a number of different items to categorize to generate a statistically relevant sample size. An attitude value is then generated based on the reaction times where short reaction times correspond to stronger correlations and longer reaction times correspond to weaker correlations.

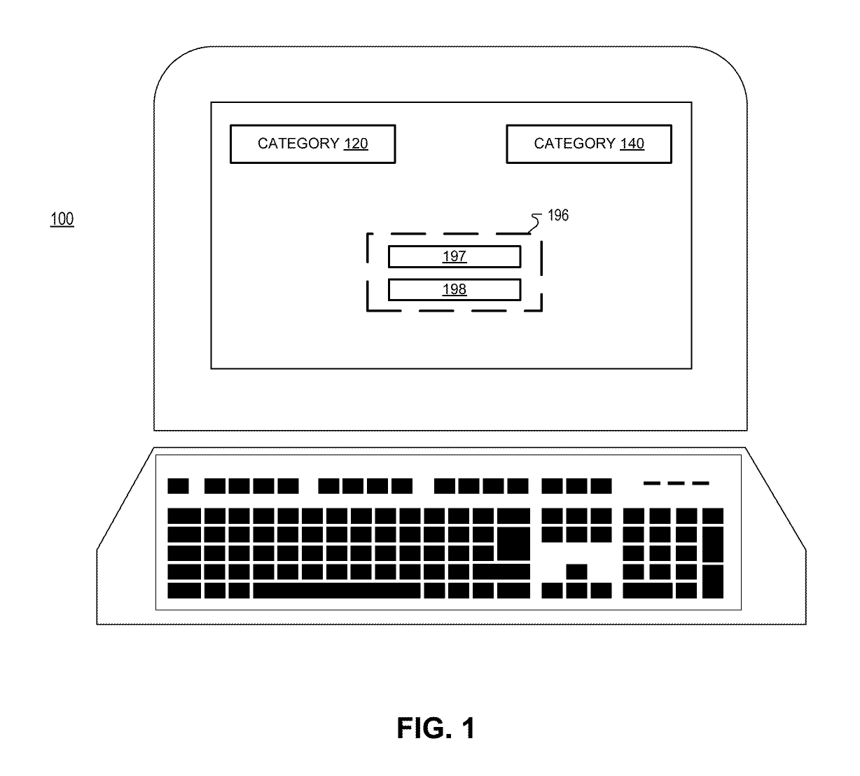

In one illustrative example, the target categories of “Flowers” and “Insects” are rendered to a display of a computer or mobile device. A pairing that includes a member (e.g. Lovely) of a first association category (e.g. positive attributes) and an item (e.g. Lilac) linked to one of the target categories is also rendered to the display. A user must first determine which of the two presented items is a member of the “Flowers” or “Insects” category and then select which category it belongs to by selecting a key on a keyboard or a software button on a touchscreen that corresponds to the category. In one example, the user selects the “e” key on a keyboard to correctly categorize the Lovely/Lilac pairing as belonging to the “Flowers” category. The reaction time of the user from when the Lovely/Lilac pairing is rendered to the display until when the user correctly selects the “Flowers” category is measured. Briefly turning to FIG. 1, “Flowers” may be rendered as target category 120 and “Insects” may be rendered as target category 140 while “Lovely” may be rendered to first rendering zone 197 of pairing 196 and “Lilac” may be rendered to second rendering zone 198 of pairing 196, in one specific illustrative example. In one embodiment, the first rendering zone and 197 and the second rendering zone 198 may be displayed close enough together such that a viewer of the display is not required to move her eyes (or move her eyes very little) to read a word or view an image in first rendering zone 197 and second rendering zone 198.

A pairing that includes a member (e.g. gross) of a second association category (e.g. negative attribute) and an item (e.g. Wasp) linked to the “Insect” category may also be rendered to the display and the user can select the “Insect” category by pressing an “i” key of a keyboard or a software button on a touchscreen that corresponds to the “Insect” category. The reaction time of the user from when the Gross/Wasp pairing is rendered to the display until when the user correctly selects the “Insects” category is measured. In the specific illustrated embodiment, the first association category is positive attributes which opposes the negative attributes that is the second association category.

Additionally, Flower items (e.g. Rose, Daisy, Pansy) are paired with members of the second association category (e.g. negative attributes such as disgusting, nasty, gross) and the categorization reaction times of users is measured. The Insect items (e.g. beetle, mosquito, ant) are paired with members of the first association category (e.g. positive attributes such as nice, beautiful, lovely) and the categorization reaction times of users are measured.

In this illustrative example of the Flower and Insect target categories, most users have faster reaction times for the first pairing (flowers paired with positive attributes) and the second pairing (insects paired with negative attributes) because the pairing are more congruent in the user's mind. In contrast, most users have slower reaction times with the third pairings (flowers paired with negative attributes) and the fourth pairings (insects paired with positive attributes) because the pairings are less congruent in the user's mind. Hence, the reaction times in categorizing the pairings are indicative of a user's attitudes toward the different categories and an attitude value can be generated based on the reaction times. In this illustrative example, the difference in reaction times would indicate a positive attitude towards flower relative to insects. While measuring people's attitudes toward Insects and Flowers is for light hearted illustration purposes, similar techniques can be used to measure user's attitudes toward sensitive issues such as male vs. female, dark skin tone vs. light skin tone, or old vs. young, for example. More features and examples of the devices and processes of the disclosure are described below.

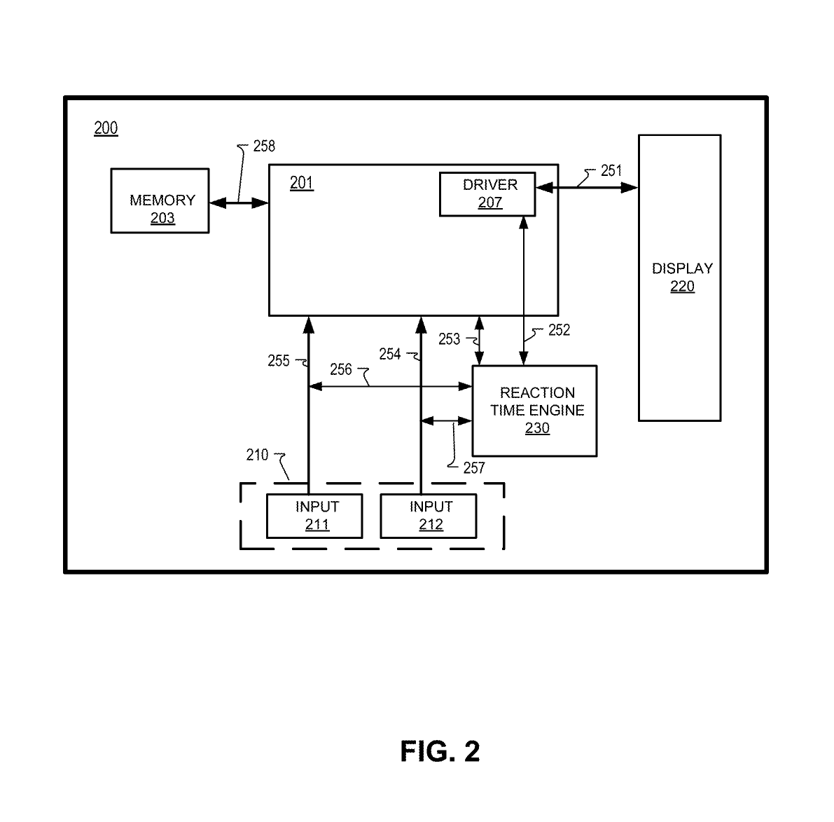

FIG. 2 illustrates an example device 200 for measuring reaction times to generate implicit attitude values, in accordance with an embodiment of the disclosure. Device 200 includes processing logic 201, memory 203, a user input interface 210, a display 220, and a reaction time engine 230. Device 200 may include a personal computer or a mobile device (e.g. smart phone, tablet, wearable, etc.), in some embodiments.

The term “processing logic” (e.g. 201) in this disclosure may include one or more processors, microprocessors, multi-core processors, and/or Field Programmable Gate Arrays (FPGAs) to execute operations disclosed herein. In some embodiments, non-transitory computer-readable memories (not illustrated) are integrated into the processing logic to store instructions to execute operations and/or store data. Processing logic may include analog or digital circuitry to perform the operations disclosed herein.

A “memory” or “memories” (e.g. 203) described in this disclosure may include volatile or non-volatile memory architectures. In FIG. 2, processing logic 201 is coupled to memory 203. Processing logic 201 may be configured to read and/or write to memory 203 via communication channel 258. In one embodiment, communication channel 258 includes a parallel bus interface. In this disclosure, “communication channel” (e.g. 251, 252, 253, 254, 255, 256, 257, and 258) may include wired or wireless communications utilizing IEEE 802.11 protocols, BlueTooth, SPI (Serial Peripheral Interface), I²C (Inter-Integrated Circuit), USB (Universal Serial Port), CAN (Controller Area Network), cellular data protocols (e.g. 3G, 4G, LTE, 5G), or otherwise.

Processing logic 201 includes a display driver 207 configured to drive images onto display 220. Display 220 may be an LCD (liquid crystal display), plasma display, or AMOLED (active matrix organic light emitting diode) display, for example.

User input interface 210 includes a first user input 211 and a second user input 212. First user input 211 is configured to output a first signal when a user selects the first user input 211. Second user input 212 is configured to output a second signal when a user selects the second user input 212. As will be described in more detail, first user input 211 may correspond to selecting a first target category and second user input 212 may correspond to a second target category. Processing logic 201 is coupled to receive the first signal from input 211 via communication channel 255, in the illustrated embodiment. Processing logic 201 is coupled to receive the second signal from input 212 via communication channel 254, in the illustrated embodiment. In one embodiment, the first signal and the second signal are digital highs or lows and communication channels 254 and 255 are simply wire traces going to I/O (input/output) pins of processing logic 201.

In the illustrated embodiment, reaction time engine 230 is coupled to receive the first signal from the first user input 211 (via communication channel 256 connected to communication channel 255) and coupled to receive the second signal from the second user input 212 (via communication channel 257 connected to communication channel 254). In the illustrated embodiment, reaction time engine 230 is also coupled to display driver 207 via communication channel 252 to sense when display driver 207 renders certain images (e.g. pairings) to display 220. Hence, reaction time engine 230 may be configured to generate a reaction time between rendering a given image and a user selection of a user input that corresponds to a target category that is rendered to display 220. The reaction time may be sent from reaction time engine 230 to processing logic 201 via communication channel 253. In one embodiment (not illustrated) reaction time engine 230 is included in processing logic 201.

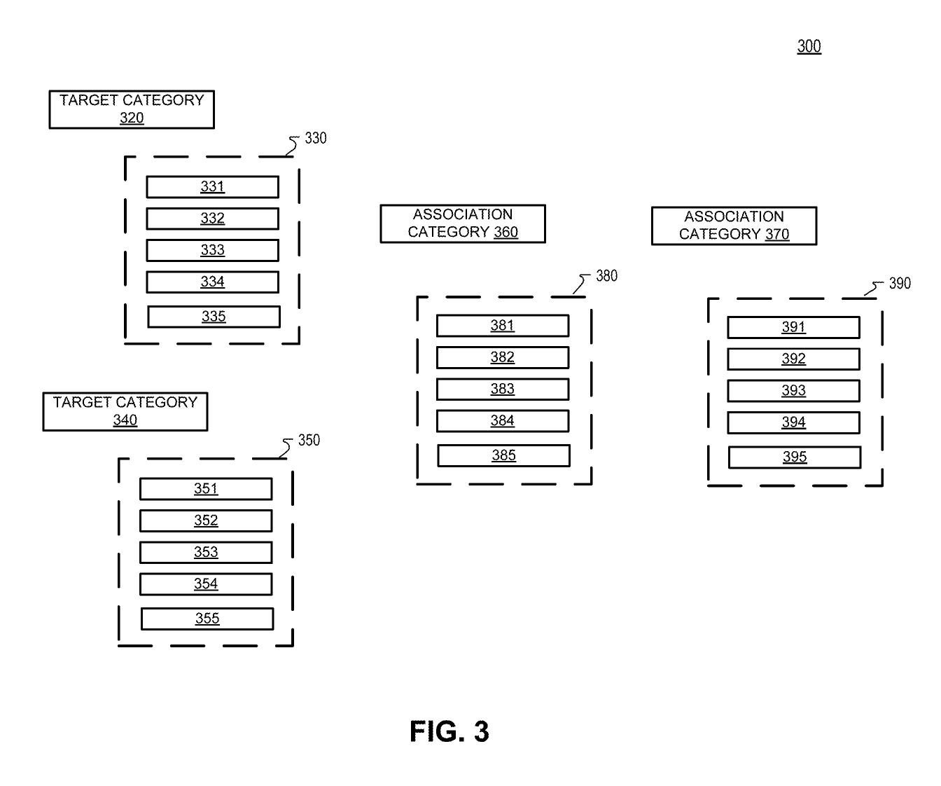

FIG. 3 illustrates an example data set 300 that may be utilized to generate implicit attitude values, in accordance with an embodiment of the disclosure. In one embodiment, data set 300 is included in memory 203. Example data set 300 includes a first target category 320, a second target category 340, a first association category 360, and a second association category 370. Data set 300 also includes a plurality of first items 330, a plurality of second items 350, a plurality of first members 380, and a plurality of second members 390. In some embodiments, (not illustrated), the first association category 360 and the second association category 370 are not saved to memory 203 although first members 380 and second members 390 are saved to memory 203.

Target category 320 and target category 340 are examples of category 120 and category 140. In the illustrated embodiment, the plurality of first items 330 includes items 331, 332, 333, 334, and 335. Each of the items in the plurality of first items 330 is associated with target category 320 in computer-readable medium (e.g. memory 203) such that target category 320 is the “correct” category for each of the first items 330. Each of the first items 330 may be associated with target category 320 in any way known in the art, including linking each item with target category 320 or including first items 330 in a data structure where each of the first items 330 are a sub-species of the target category 320. In the illustrated embodiment, the plurality of second items 350 includes items 351, 352, 353, 354, and 355. Each of the items in the plurality of second items 350 is associated with target category 340 in a computer-readable medium (e.g. memory 203) such that target category 340 is the “correct” category for each of the second items 350. Each of the second items 350 may be associated with target category 340 in any way known in the art, including linking each item with target category 340 or including second items 350 in a data structure where each of the second items 350 are a sub-species of the target category 340.

In the illustrated embodiment, the plurality of first members 380 of first association category 360 includes members 381, 382, 383, 384, and 385. The plurality of second members 390 of second association category 370 includes members 391, 392, 393, 394, and 395. In one embodiment, the first association category 360 opposes the second association category 370 and, consequently, the first members 380 oppose the second members 390.

In a first specific illustrative example, target category 320 is “Flowers” and target category 340 is “Insects.” The plurality of first items 330 includes “Lilac” as item 331, “Rose” as item 332, “Daffodil” as item 333, “Violet” as item 334, and “Poppy” as item 335. The plurality of second items 350 includes “Moth” as item 351, “Wasp” as item 352, “Beetle” as item 353, “Termite” as item 354, and “Ant” as item 355. In this first specific illustrative example, the items are sub-species of their respective categories. The items are associated to their target category such that a user's categorization of any of the plurality of items 330 as corresponding to target category 320 is considered a “correct” categorization and such that a user's categorization of any of the plurality of items 350 as corresponding to target category 340 is considered a “correct” categorization.

Still referring to the first specific illustrative example, a plurality of first members 380 includes “Beautiful” as member 381, “Lovely” as member 382, “Wonderful” as member 383, “Peaceful” as member 384, and “Delightful” as member 385. A plurality of second members 390 includes “Terrible” as member 391, “Awful” as member 392, “Disgusting” as member 393, “Filthy” as member 394, and “Ugly” as member 395.

The “target categories” of the disclosure are the subject of the attitude of the user desired to be measured. The items associated with the different target categories may be sub-species of the target categories. In the first specific illustrative embodiment, the first association category may be “positive attribute” and the second association category may be “negative attribute.” The “association categories” of the disclosure may never be rendered to the display for the user to view, yet the members of the association category will be rendered to the display as part of a pairing. In one embodiment, the association categories are opposing categories. For example, “positive attributes” would oppose “negative attributes” when the association test concerns measuring positive and negative attitudes toward the target categories. In another example, the association categories are “Democrat” vs. “Republican.”

In a second specific illustrative example, target category 320 is “Self” and target category 340 is “Others.” The second specific illustrative example may be used to measure a person's attitudes regarding self-esteem or suicidality, for example. The plurality of first items 330 includes “I” as item 331, “Myself” as item 332, “Mine” as item 333, “My” as item 334, and “Me” as item 335. The plurality of second items 350 includes “Them” as item 351, “They” as item 352, “Their” as item 353, “Themselves” as item 354, and “Theirs” as item 355. In this second specific illustrative example, the items are associated with their respective target categories.

Still referring to the second specific illustrative example, a plurality of first members 380 includes “Happy” as member 381, “Alive” as member 382, “Thrive” as member 383, “Cheer” as member 384, and “Flourish” as member 385 that belong to a first association category 360. In this case, the first association category 360 may be characterized as life-affirming attributes and members 381-385 are life-affirming attributes. A plurality of second members 390 includes “Hopeless” as member 391, “Dead” as member 392, “Suicide” as member 393, “Die” as member 394, and “Despair” as member 395. In this case, the first association category 370 may be characterized as life-negating attributes and members 391-395 are life-negating attributes.

In one embodiment, each of the first items 330 is potentially descriptive of, or associated with target category 320. In one embodiment, each of the second items 350 is descriptive of, or associated with target category 340. In one embodiment, each of the first members 380 is potentially descriptive of, or associated with association category 360. In one embodiment, each of the second members 390 is descriptive of, or associated with association category 370.

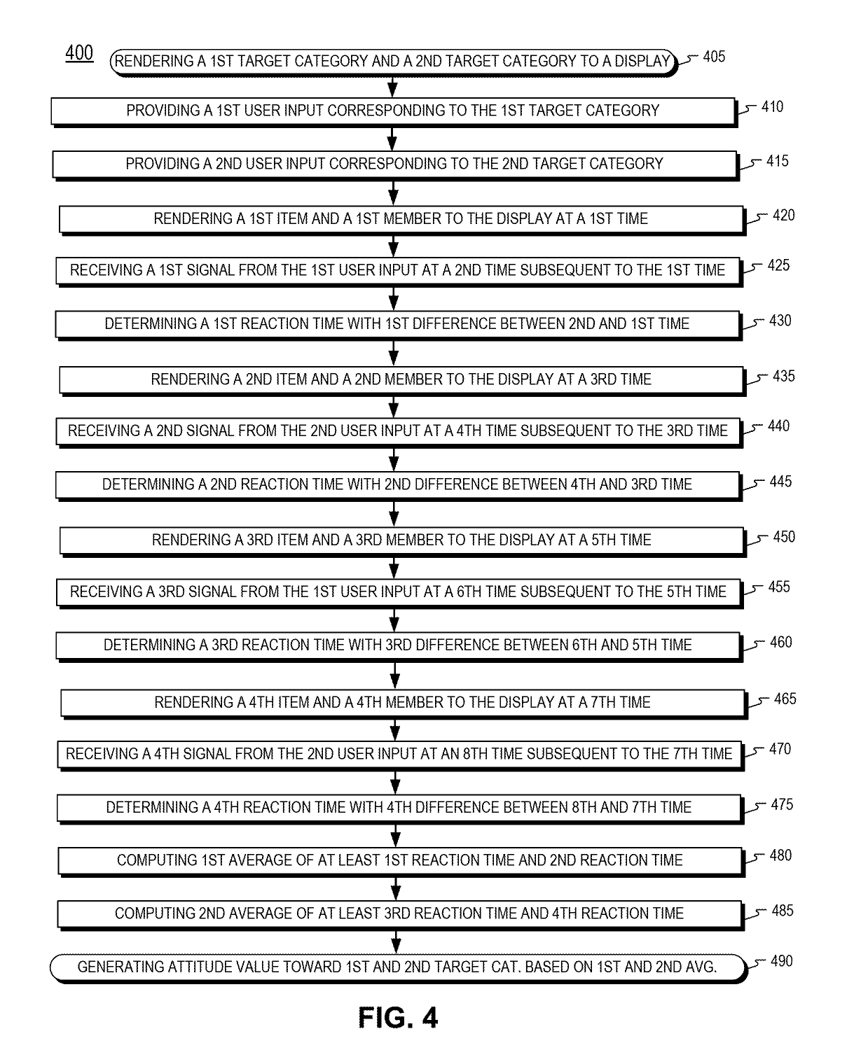

FIG. 4 illustrates a flowchart showing one example process 400 of generating implicit attitude values by measuring reaction times, in accordance with an embodiment of the disclosure. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

In process block 405, a first target category (e.g. 320) and a second target category (e.g. 340) is rendered to a display (e.g. 220).

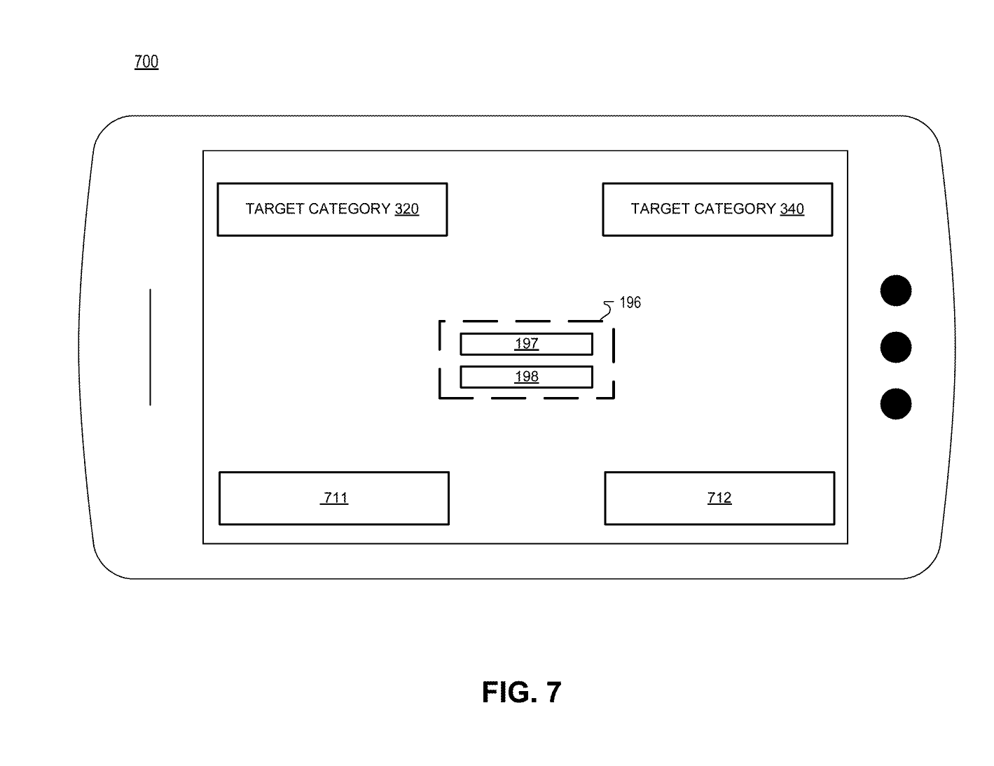

In process block 410, a first user input corresponding to the first target category is provided. In process block 415, a second user input corresponding to the second target category is provided. In one embodiment, the first user input is a first key on a computer keyboard and the second user input is a second key on the computer keyboard. In one embodiment, the first user input is a first software button displayed under a first zone of a touch-screen interface and the second user input is a second software button displayed under a second zone of the touch-screen interface. In FIG. 7, software button 711 is displayed under a first zone of a touch-screen interface (not illustrated) of mobile device 700 and software button 712 is displayed under a second zone of the touch-screen interface, in accordance with an embodiment of the disclosure. The software button 711 may correspond with category 320 and software button 712 may correspond with category 340.

In process block 420, a first item (e.g. lily) and a first member (e.g. beautiful) is rendered to the display at a first time where the first item is linked to the first target category. The first item is one of the plurality of first items 330 that are linked to the first target category 320 and the first member is one of the plurality of first members 380 linked to a first association category 360 (e.g. positive attribute). The rendering of an item paired with a member may be referred to as a “pairing” in this disclosure. When a pairing includes one of the plurality of first items 330 and one of the first members 380, the pairing may be referred to as a “first pairing” for the purposes of this disclosure.

In process block 425, a first signal from the first user input is received at a second time subsequent to the first time. Since the first item (e.g. lily) is linked to the first target category (e.g. flower), a user's selection of the first user input corresponding to the first target category indicates a “correct” selection while a user's selection of the second user input corresponding to the second target category would indicate an “incorrect” selection.

In process block 430, a first reaction time is determined. The first reaction time is a first difference between the second time and the first time.

In process block 435, a second item (e.g. wasp) and a second member (e.g. gross) is rendered to the display at a third time where the second item is linked to the second target category. The second item is one of the plurality of second items 350 that are linked to the second target category 340 and the second member is one of the plurality second members 390 linked to a second association category 370 (e.g. negative attribute). When a pairing includes one of the plurality of items 350 and one of the second members 390, the pairing may be referred to as a “second pairing” for the purposes of this disclosure. In one embodiment, the second association category opposes the first association category. In one embodiment, each of the first members opposes each of the second members.

In process block 440, a second signal from the second user input is received at a fourth time subsequent to the third time. Since the second item (e.g. wasp) is linked to the second target category (e.g. insect), a user's selection of the second user input corresponding to the second target category indicates a “correct” selection.

In process block 445, a second reaction time is determined. The second reaction time is a second difference between the fourth time and the third time.

In one embodiment, process blocks 420, 425, and 430 are executed many times to generate multiple reaction times that measure a user's reaction time to correctly categorizing any of the plurality of items 330 (that are linked with the first target category) to the first target category when the items in the plurality of first items 330 are paired with any of the members in the plurality of first members 380 (first pairings).

In one embodiment, process blocks 435, 440, and 445 are executed many times to generate multiple reaction times that measure a user's reaction time to correctly categorizing any of the plurality of items 350 (that are linked with the second target category) to the second target category when the items in the plurality of second items 350 are paired with any of the members in the plurality of second members 390 (second pairings).

Measuring many reaction times for the first pairings and second pairings may increase the reliability of attitude values that are generated by measuring the reaction times.

In process block 450, a third item (e.g. violet) and a third member (e.g. gross) is rendered to the display at a fifth time where the third item is linked to the first target category 320. The third item is one of the plurality of items 330 that are linked to the first target category 320 and the third member is one of the plurality second members 390 linked to the second association category 370. When a pairing includes one of the plurality of first items 330 and one of the second members 390, the pairing may be referred to as a “third pairing” for the purposes of this disclosure.

In process block 455, a third signal from the first user input is received at a sixth time subsequent to the fifth time. Since the third item (e.g. violet) is linked to the first target category (e.g. flowers), a user's selection of the first user input corresponding to the first target category indicates a “correct” selection.

In process block 460, a third reaction time is determined. The third reaction time is a third difference between the sixth time and the fifth time.

In process block 465, a fourth item (e.g. beetle) and a fourth member (e.g. lovely) is rendered to the display at a seventh time where the fourth item is linked to the second target category 340. The fourth item is one of the plurality of second items 350 that are linked to the second target category 340 and the fourth member is one of the plurality of first members 380. When a pairing includes one of the plurality of items 350 and one of the members of the plurality of first members 380, the pairing may be referred to as a “fourth pairing” for the purposes of this disclosure.

In process block 470, a fourth signal from the second user input is received at an eighth time subsequent to the seventh time. Since the fourth item (e.g. beetle) is linked to the second target category (e.g. insects), a user's selection of the second user input corresponding to the second target category indicates a “correct” selection.

In process block 475, a fourth reaction time is determined. The fourth reaction time is a fourth difference between the eighth time and the seventh time.

In one embodiment, process blocks 450, 455, and 460 are executed many times to generate multiple reaction times that measure a user's reaction time to correctly categorizing any of the plurality of items 330 (that are linked with the first target category) to the first target category when the items in the plurality of items 330 are paired with any of the members of the plurality of second members 390 (third pairings).

In one embodiment, process blocks 465, 470, and 475 are executed many times to generate multiple reaction times that measure a user's reaction time to correctly categorizing any of the plurality of items 350 (that are linked with the second target category) to the second target category when the items in the plurality of items 350 are paired with any of the members of the plurality of first members 380 (fourth pairings).

Measuring many reaction times for the third pairings and fourth pairings may increase the reliability of attitude values that are generated by measuring the reaction times. In one embodiment, the first and second target category are rendered to the display from the first time until the eighth time. In one embodiment, the first and second target category are rendered to the display between the first and second time, between the third and fourth time, between the fifth and sixth time, and between the seventh and eighth time.

In process block 480, a first average of at least the first reaction time and the second reaction time is computed. In process block 485, a second average of at least the third reaction time and the fourth reaction time is computed.

In process block 490, an attitude value toward the first and second categories is generated based at least in part on a difference between the first average and the second average. In the Flowers/Insects illustrative example, a first average of 0.25 seconds and second average of 1.5 seconds would indicate that the user has a very positive attitude toward flowers (and a negative attitude toward insects). In one illustrative example, an attitude value is within a range of −2 to 2 where an attitude value of 2 indicates the strongest positive attitude toward flowers and an attitude value of −2 indicates a strong positive attitude toward insects. Of course, other values and other ranges may be used.

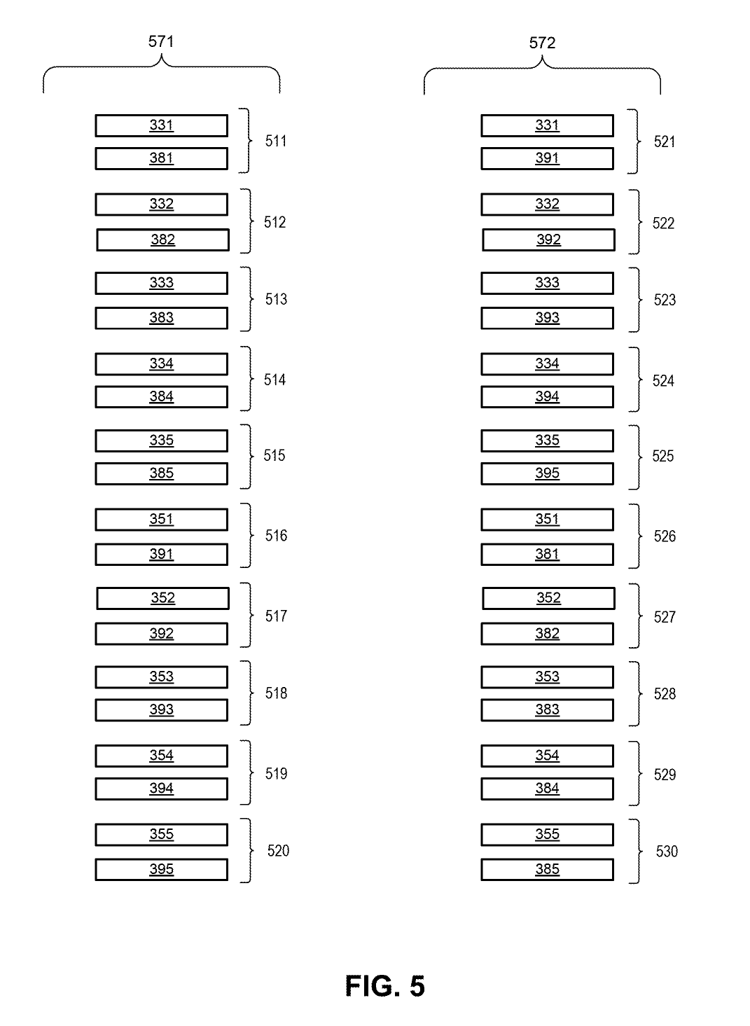

FIG. 5 illustrates example reaction time measurement blocks 571 and 572 that include pairing to be presented to the user for categorization and reaction time measurement, in accordance with an embodiment of the disclosure. In the illustrated embodiment, reaction time measurement block 571 includes pairing 511, 512, 513, 514, 515, 516, 517, 518, 519, and 520. First pairings 511, 512, 513, 514, and 515 include an item from the plurality of items 330 that correspond with target category 320 and a member of the plurality of members 380. Second pairings 516, 517, 518, 519, and 520 include an item from the plurality of items 350 that correspond with target category 340 and a member of the plurality of members 390.

In the illustrated embodiment of FIG. 5, reaction time measurement block 572 includes pairing 521, 522, 523, 524, 525, 526, 527, 528, 529, and 530. Third pairings 521, 522, 523, 524, and 525 include an item from the plurality of items 330 that correspond with target category 320 and a member of the plurality of members 390. Fourth pairings 526, 527, 528, 529, and 530 include an item from the plurality of items 350 that correspond with target category 340 and one of the members of the plurality of members 380.

As described in association with process 400, presenting multiples of the first pairing, the second pairings, the third pairings, and the fourth pairings to measure a user's reaction time for categorization may be useful to generate more useful statistics for analysis.

Hence, in one embodiment, reaction time measurement block 571 is presented to the user for categorizing each of the first pairings and the second pairings into the first and second target category. In one embodiment, the reaction time measurement block 571 includes intermixing the renderings of the first and second pairings so that the user cannot predict if one of the first pairings or one of the second pairings will be presented next. In one embodiment, the first pairings and second pairings are randomly rendered to the display for reaction time measurement block 571.

In one embodiment, reaction time measurement block 572 is presented to the user for categorizing each of the third pairings and the fourth pairings into the first and second target category. In one embodiment, the reaction time measurement block 572 includes intermixing the renderings of the third and fourth pairings so that the user cannot predict if one of the third pairings or one of the fourth pairings will be presented next. In one embodiment, the third pairings and fourth pairings are randomly rendered to the display for reaction time measurement block 572.

In one embodiment, two reaction time measurement blocks 571 are presented to the user for categorizing and two reaction time measurement blocks 572 are presented to the user for categorizing. The number of pairings presented in each reaction time measurement block may vary. In one embodiment, twenty pairings are presented in each of the reaction time measurement blocks and twenty reaction times corresponding to the categorization of the pairings are measured. In one embodiment, reaction time measurement blocks are separated by a rest period. In one embodiment, the reaction time measurement blocks are preceded by a training module that includes rendering two categories to the display and only one item (without being paired with a member) so the user can learn to match the item with the correct category using the first user input and the second user input.

As described above, each pairing has an item and a member. In FIG. 1, an item of a pairing may be rendered to a first rendering zone 197 or a second rendering zone 198 and the member of a pairing will be rendered to the rendering zone that is not occupied by the item. In one embodiment, the items and members are unpredictably rendered to the first rendering zone 197 or the second rendering zone 198 of the respective pairing so that a user cannot simply ignore the members that are included with the items in the pairing by virtue of the member's continual same position in a same rendering zone.

With regard to process block 490, in some embodiments, generating the attitude value toward the first and second target categories includes measuring a variability of the first, second, third, and fourth reaction times, adjusting a weighting value based on the variability of the reaction times, and applying the weighting value to a raw attitude value to generate the attitude value. The raw attitude value may simply be the difference between the first and second average. In embodiments where multiple first, second, third, and fourth pairings are rendered and corresponding reaction times measured, the measuring of variability, adjusting a weighting value, and applying the weighting value to a raw attitude value to generate the attitude value may also be performed on the multiple reaction times. During experimentation and corresponding statistical analysis, Applicant's data indicates that more tightly bracketed (less variability) reaction times are indicative of a higher assurance that the raw attitude value is legitimate. Thus, less variability in the reaction times may warrant increasing the weighting value such that the attitude value is increased to reflect a stronger attitude toward one of the target categories. Applicant's data also indicates that more dispersed (more variability) reaction times are indicative of a lower assurance that the raw attitude value is legitimate. Thus, more variability in the reaction times may warrant decreasing the weighting value such that the attitude value is decreased to reflect a less strong attitude toward one of the categories.

In one embodiment, the variability in reaction times is separately calculated for the first reaction time measurement blocks 571 that include the first pairings and second pairings and separately calculated from the second reaction time measurement blocks 572 that include the third and fourth pairings since reaction time variability between the two different measurement blocks is common and expected. In one embodiment, standard deviation techniques are used to quantify the variability of the reaction times.

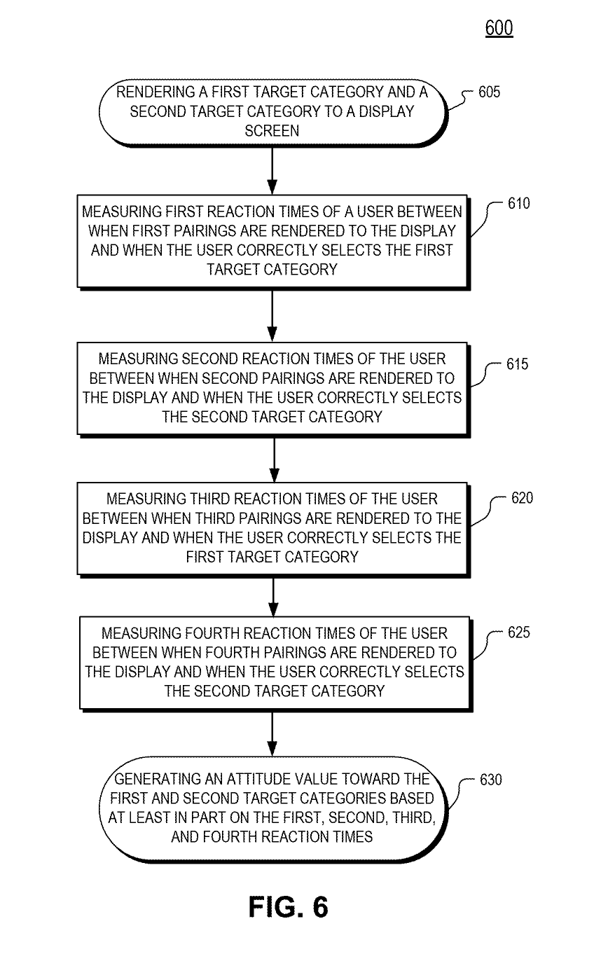

FIG. 6 illustrates a flowchart showing one example process 600 of generating implicit attitude values by measuring a plurality of reaction times, in accordance with an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In process block 605, a first target category and a second target category is rendered to a display.

In process block 610, first reaction times of a user are measured. The first reaction times are measured between when first pairings (e.g. 511, 512, 513, 514, or 515) are rendered to the display and when the user correctly selects the first target category (via a first user input, for example), where each of the first pairings includes one of a plurality of first items (e.g. 330) that are linked to the first target category (e.g. 320). Each of the first pairings also include one of a plurality of first members (e.g. 380).

In process block 615, second reaction times of a user are measured. The second reaction times are measured between when second pairings (e.g. 516, 517, 518, 519, or 520) are rendered to the display and when the user correctly selects the second target category (via a second user input, for example), where each of the second pairings includes one of a plurality of second items (e.g. 350) that are linked to the second target category (e.g. 340). Each of the second pairings also include one of a plurality of second members (e.g. 390).

In process block 620, third reaction times of a user are measured. The third reaction times are measured between when third pairings (e.g. 521, 522, 523, 524, or 525) are rendered to the display and when the user correctly selects the first target category, where each of the third pairings includes one of a plurality of the first items (e.g. 330) that are linked to the first target category (e.g. 320). Each of the third pairings also include one of the plurality of second members (e.g. 390).

In process block 625, fourth reaction times of a user are measured. The fourth reaction times are measured between when fourth pairings (e.g. 526, 527, 528, 529, or 530) are rendered to the display and when the user correctly selects the second target category, where each of the fourth pairings includes one of a plurality of the second items (e.g. 350) that are linked to the second target category (e.g. 340). Each of the fourth pairings also include one of the plurality of first members (e.g. 380).

In process block 630, an attitude value toward the first and second target categories is generated based at least in part on the first, second, third, and fourth reaction times. In some embodiments, generating the attitude value toward the first and second target categories includes measuring a variability of the first, second, third, and fourth reaction times, adjusting a weighting value based on the variability of the reaction times, and applying the weighting value to a raw attitude value to generate the attitude value. The raw attitude value may simply be the difference between the first and second average. In one embodiment, when the variability of the reaction times is low, the weighting is increased, and when the variability is high, the weighting is decreased.

In embodiments of the disclosure, words/text are rendered to the display as part of a pairing. For example, the words “beetle,” “ant,” “rose,” “lily,” “happy,” and “hopeless” may be rendered to the display screen as part of pairings. However, images may also be rendered to the screen instead of words/text. In one embodiment, a video is played on the screen as part of the pairing. In one embodiment, audio is played on the speakers of a computer or mobile device instead of words/text in the pairing. In one embodiment, the first members are images and/or the second members are images. In one illustrative example, an image of a person smiling is substituted for the positive attribute of the word “happy” (a member of 380, in one example) or an image of a person appearing sad could be substituted for the negative attribute of the word “hopeless” (a member of 390, in one example). In one embodiment, at least one of the first, second, third, and fourth items include an image that is rendered to the display. In one illustrative example, an image of a rose could replace the item of the word “rose.” In one illustrative example, an image of a beetle could replace the item of the word “beetle.”

The potential advantages of the disclosed devices and systems include automating implicit attitude tests, increasing the speed and efficiency of which implicit attitude tests may be administered and taken, and increasing the accuracy of measuring implicit attitudes.

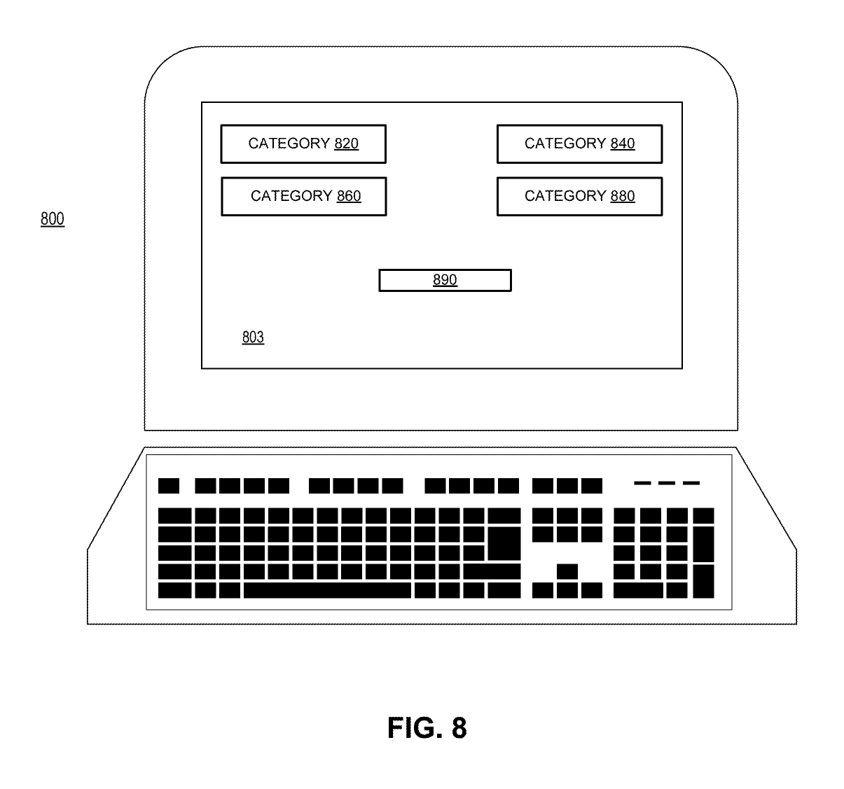

FIG. 8 illustrates a computing device 800 having a display 803 rendering a first category 820, a second category 840, a third category 860, a fourth category 880, and an element 890. The rendering on the display 803 represents a prior process of administering an IAT implemented at least in part by the Applicant. In the prior implementation of a the IAT illustrated in FIG. 8, a user is asked to select which category that the element 890 belongs to. In one example, first category 820 is “flowers,” second category 840 is “insects,” third category 860 is “good,” and fourth category 880 is “bad.” Element 890 is rendered to the screen. Examples of element 890 are “beetle,” “glorious,” “daisy,” and “agony.” If element 890 belongs with first category 820 or third category 860, a first user input would be selected to properly categorize element 890 with category 820 or 860. If element 890 belongs with second category 840 or fourth category 880, a second user input would be selected to properly categorize element 890 with category 840 or 880. Hence, when element 890 is the word “beetle,” the second user input should be selected to correctly categorize “beetle” with second category 840 “insect.” When the element 890 is the word “glorious,” the first user input should be selected to correctly categorize “glorious” with third category 860 “good.” When the element 890 is the word “daisy,” the first user input should be selected to correctly categorize “daisy” with first category 820 “flower.” When the element 890 is the word “agony,” the second user input should be selected to correctly categorize “agony” with fourth category 880 “bad.” In different testing blocks of FIG. 8, the categories 820, 840, 860, and 880 may be moved to correspond with different user inputs. For example, in another testing block, the same elements 890 are presented, but the categories 820 and 880 are on the left side of the display 803 and correspond with the first user input and categories 840 and 860 are on the right side of the display 803 and correspond with the second user input.

The disclosed embodiments of the disclosure described in association with FIGS. 1-7 differ from the implementation of FIG. 8. Perhaps most apparently, the implementation of FIG. 8 presents the user with element 890 to be categorized into one of four different categories rather than presenting the user with a pairing to be sorted into two different categories. Applicant's experimentation data suggests that the embodiments of FIG. 1-7 are more accurate and/or more efficient than the embodiment of FIG. 8. Since the implementation of FIG. 8 includes four categories, the user must attempt to keep four categories in mind while categorizing element 890, which may result in the user's eyes scanning back and forth between categories 820, 840, 860, and 880 to see which category that element 890 should belong to. This may contribute to a longer testing period and perhaps more importantly injects additional variables into any reaction time data that would be measured. For instance, the time it takes for a user to scan back and forth between the four categories is an additional variable that will contribute to a reaction time that is measured for how long it takes a user to correctly categorize element 890. Adding additional variables to the reaction time may obfuscate the raw reaction time that the test seeks to measure.

In contrast to the implementation of FIG. 8, the embodiments of FIGS. 1-7 only have two categories. Limiting to two categories allows the user to keep the categories fully in mind without the need for a user's eyes to scan back and forth between the categories, which may reduce the injection of an extraneous variable (e.g. eye scanning time) and better measure the raw reaction time of the user. Rather, since the item and the members in embodiments of the disclosure are presented so closely within the pairing and the user need only view the item and member (instead of the remembering or viewing the 4 categories of FIG. 8), the eyes of the user may not need to move at all or move very minimally. Additionally, since the items and members of the embodiments of FIGS. 1-7 may unpredictably change between first rendering zone 197 and second rendering zone 198, the user still encounters the incongruence or congruence of two concepts (provided by the item and the member) within the pairing 196 for gauging implicit attitudes.

The features described in the preceding paragraph also contribute to a simpler possible testing interface, fewer required instructions for the testing, potentially eliminating training blocks of the test altogether, and as a result, a faster testing process with fewer invalid testing results. Additionally, Applicant has observed that the reduction in eye scanning between categories and reducing or eliminating the need for a user to remember the instructions contributes to a decreased variability in reaction times which allows for fewer testing iterations (e.g. pairings) to be presented to the user to generate statistically stable averages. Thus, the test can be administered in a shorter amount of time and consume less processing resources.

Describing yet another advantage of the features of the embodiments of the disclosure, the implementation of FIG. 8 required that categories 860 and 880 be switched midway through an association test in order to test the congruence/incongruence of category 820 with category 880 and the congruence/incongruence of category 840 with category 860, which meant participants (users) had to unlearn the previous instructions and relearn the new instructions for the second portion/half of the test. Hence, the test result of FIG. 8 was susceptible to being influenced by the order in which categories 820/840/860/880 were presented together as the reaction times in the first portion of the association test tended to be shorter than the reaction times of the second portion of the test simply by virtue of the participant learning the first instructions first and having to unlearn the first instructions and learn the second instructions for the second portion of the test. Compensating for the order of the first portion of the test and the second portion of the test of FIG. 8 could be achieved by aggregating test results from a large group of participants, but evaluating an individual test with the individual test data alone was problematic. In contrast to the implementation of FIG. 8, the embodiments of FIGS. 1-7 allow for a uniform instruction to be given throughout the whole association test, which allows for a more accurate attitude score to be generated based on an individual test and consequently saves the processing resources previously required to aggregate multiple test result data to counterbalance the change of instructions from the first and second portions of the test, as needed in the implementation of FIG. 8.

Therefore, disclosed herein is a technical solution to the long standing technical problem in the implicit attitude testing industry of more accurately and more efficiently measuring implicit attitudes. However, the disclosed device and method for measuring reaction times to generate implicit attitude values does not encompass, embody, or preclude other forms of innovation in the implicit attitude or implicit bias testing. In addition, the disclosed device and method for measuring reaction times to generate implicit attitude values is not related to any fundamental economic practice, mental steps, or pen and paper based solution. In fact, the disclosed embodiments would not be possible using a pen and paper solution because pen and paper surveys are susceptible to surveyors consciously or unconsciously gaming the surveys and pen and paper surveys are not capable of measuring reaction times from when a pairing is rendered to the screen and when a user correctly categorizes the pairing. Consequently, the disclosed device and method for measuring reaction times to generate implicit attitude values is not directed to, does not encompass, and is not merely, an abstract idea or concept.

In addition, the disclosed device and method for measuring reaction times to generate implicit attitude values provides for significant improvements to the technical fields of implicit attitude testing including faster and more accurate implicit attitude testing while consuming fewer processor resources. Consequently, using the disclosed device and method for measuring reaction times to generate implicit attitude values results in more efficient use of human and non-human resources, fewer processor cycles being utilized, and reduced memory utilization. As a result, computing systems and devices are transformed into faster, more efficient, and more effective computing systems by implementing the disclosed device and method for measuring reaction times to generate implicit attitude values.

The processes and methods explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A device for measuring reaction times to generate implicit attitude values, the device comprising:
a display configured to render images;
a first user input configured to output a first signal when a user selects the first user input;
a second user input configured to output a second signal when the user selects the second user input;
a reaction time engine coupled to receive the first signal from the first user input and coupled to receive the second signal from the second user input;
a memory; and
processing logic communicatively coupled to the memory, wherein the memory includes instructions that cause the device to execute operations comprising:
rendering a first and second target category to the display;
measuring, with the reaction time engine, a first reaction time of the user between when a first pairing is rendered to the display and a first correct user selection of the first target category linked to a first item of the first pairing, wherein the first pairing also includes a first member linked to a first association category;
measuring, with the reaction time engine, a second reaction time of the user between when a second pairing is rendered to the display and a second correct user selection of the second target category linked to a second item of the second pairing, wherein the second pairing also includes a second member linked to a second association category that opposes the first association category;
measuring, with the reaction time engine, a third reaction time of the user between when a third pairing is rendered to the display and a third correct user selection of the first target category linked to a third item of the third pairing, wherein the third pairing also includes a third member linked to the second association category;
measuring, with the reaction time engine, a fourth reaction time of the user between when a fourth pairing is rendered to the display and a fourth correct user selection of the second target category linked to a fourth item of the fourth pairing, wherein the fourth pairing also includes a fourth member linked to the first association category; and
generating an attitude value toward the first and second categories based at least in part on the first, second, third, and fourth reaction times.

2. The device for measuring response times to generate implicit attitude values of claim 1, wherein generating the attitude value includes:
computing a first average of at least the first reaction time and the second reaction time;
computing a second average of at least the third reaction time and the fourth reaction time; and
computing a difference value between the first average and the second average.

3. The device for measuring response times to generate implicit attitude values of claim 1, wherein the first, second, third, and fourth correct user selections are received by the first user input or the second user input.

4. The device for measuring response times to generate implicit attitude values of claim 1, wherein the device is a mobile device that further includes a touch-screen interface that overlays the display, and wherein the first user input and the second user input are zones in the touch-screen interface.

5. The device for measuring response times to generate implicit attitude values of claim 1, wherein the first member and the third member are the same, and wherein the second member and the fourth member are the same.

6. The device for measuring response times to generate implicit attitude values of claim 1, wherein the first item and the third item are the same item, and wherein the second item and the fourth item are the same.

7. The device for measuring response times to generate implicit attitude values of claim 1, wherein at least one of the first, second, third, and fourth items includes an image that is rendered to the display.

8. The device for measuring response times to generate implicit attitude values of claim 1, wherein the first, second, third, and fourth members are images.

9. A computer-implemented method of measuring reaction times to generate implicit attitude values, the computer-implemented method comprising:
rendering a first target category and a second target category to a display;
providing a first user input corresponding to the first target category;
providing a second user input corresponding to the second target category;
rendering a first item and a first member to the display at a first time, wherein the first item is linked to the first target category and the first member is linked to a first association category;
receiving a first signal from the first user input at a second time subsequent to the first time;
determining a first reaction time, wherein the first reaction time is a first difference between the second time and the first time;
rendering a second item and a second member to the display at a third time, wherein the second item is linked to the second target category and the second member is linked to a second association category that opposes the first association category;
receiving a second signal from the second user input at a fourth time subsequent to the third time;
determining a second reaction time, wherein the second reaction time is a second difference between the fourth time and the third time;
rendering a third item and a third member to the display at a fifth time, wherein the third item is linked to the first target category and the third member is linked to the second association category;
receiving a third signal from the first user input at a sixth time subsequent to the fifth time;
determining a third reaction time, wherein the third reaction time is a third difference between the sixth time and the fifth time;
rendering a fourth item and a fourth member to the display at a seventh time, wherein the fourth item is linked to the second target category and the fourth member is linked to the first association category;
receiving a fourth signal from the second user input at an eighth time subsequent to the seventh time;
determining a fourth reaction time, wherein the fourth reaction time is a fourth difference between the eighth time and the seventh time;
computing a first average of at least the first reaction time and the second reaction time;
computing a second average of at least the third reaction time and the fourth reaction time; and
generating an attitude value toward the first and second categories based at least in part on a difference between the first average and the second average.

10. The computer-implemented method of claim 9, wherein generating the attitude value toward the first and second target categories includes:
measuring a variability of reaction times of the first, second, third, and fourth reaction times;
adjusting a weighting value based on the variability of the reaction times; and
applying the weighting value to a raw attitude value to generate the attitude value, wherein the raw attitude value was the difference between the first and second average.

11. The computer-implemented method of claim 9, wherein the first and second target category are rendered to the display between the first and second time, between the third and fourth time, between the fifth and sixth time, and between the seventh and eighth time.

12. The computer-implemented method of claim 9, wherein the first, second, third, and fourth members include images rendered to the display.

13. The computer-implemented method of claim 9, wherein the first, second third, and fourth member are words.

14. A computer-implemented method of measuring reaction times to generate implicit attitude values, the computer-implemented method comprising:
rendering a first target category and a second target category to a display;
measuring first reaction times of a user between when first pairings are rendered to the display and when the user correctly selects the first target category, wherein each of the first pairings includes one of a plurality of first items that are linked to the first target category and one of a plurality of first members;
measuring second reaction times of the user between when second pairings are rendered to the display and when the user correctly selects the second target category, wherein each of the second pairing includes one of a plurality of second items that are linked to the second target category and one of a plurality of second members that oppose the plurality of first members;
measuring third reaction times of the user between when third pairings are rendered to the display and when the user correctly selects the first target category, wherein each of the third pairings include one of the plurality of first items that are linked to the first target category and one of the plurality of second members;
measuring fourth reaction times of the user between when fourth pairings are rendered to the display and when the user correctly selects the second target category, wherein each of the fourth pairings include one of the plurality of second items that are linked to the second target category and one of the plurality of first members; and
generating an attitude value toward the first and second categories based at least in part on the first, second, third, and fourth reaction times.

15. The computer-implemented method of claim 14, wherein generating the attitude value toward the first and second target categories includes:
measuring a variability of reaction times of the first, second, third, and fourth reaction times;
adjusting a weighting value based on the variability of the reaction times; and
applying the weighting value to a raw attitude value to generate the attitude value, wherein the raw attitude value was the difference between the first and second average.

16. The computer-implemented method of claim 15, wherein when the variability is low, the weighting is increased, and wherein the variability is high, the weighting is decreased.

17. The computer-implemented method of claim 14, wherein a first reaction time measurement block includes intermixing the renderings of the first and second pairings, and wherein a second reaction time measurement block includes intermixing the renderings of the third and fourth pairings, and further wherein the first reaction time measurement block and the second reaction time measurement block are separated by a rest period.

18. The computer-implemented method of claim 14, wherein the first and second items and the first members and second members are unpredictably rendered to a first rendering zone or a second rendering zone of the respective pairings.

19. The computer-implemented method of claim 14, wherein the respective reaction times of the user are measured using a touch-screen interface to sense when the user correctly selects a respective target category, and wherein a first zone of the touch-screen interface corresponds to the first target category and a second zone of the touch-screen interface corresponds to the second target category.

20. The computer-implemented method of claim 14, wherein the respective reaction times of the user are measured using a computer keyboard to sense when the user correctly selects a respective target category, and wherein a first key of the computer keyboard corresponds to the first target category and a second key of the computer keyboard corresponds to the second target category.
